(19) United States
(12) Patent Application Publication
(10) Pub. No.: US 2011/0107911 A1
(43) Pub. Date: May 12, 2011

(54) Membrane And Process For Steam Separation, Purification And Recovery

(75) Inventors: Manh Hoang, Victoria (AU); Cuong Nguyen, Victoria (AU)

(73) Assignee: Commonwealth Scientific and Industrial Research Organisation, Campbell (AU)

(21) Appl. No.: 12/935,496

(22) PCT Filed: Mar. 31, 2009
(86) PCT No.: PCT/AU2009/000386

§ 371 Date: Jan. 21, 2011

(30) Foreign Application Priority Data
Mar. 31, 2008 (AU) 2008901536

(51) Int. Cl. B01D 53/22; C09D 5/20

(52) U.S. Cl. 95/45; 96/11; 427/155

(57) ABSTRACT

A process of steam separation using a separation membrane in a separation vessel where the separation membrane separates the vessel into an intake chamber and a recovery chamber. The separation membrane comprises at least one porous support; and a cross-linked hydrophilic polymer membrane material with an inorganic particulate material or a precursor to an inorganic particulate material. The membrane material is applied to the porous support. The process comprises supplying steam to be purified to the intake chamber of the vessel, the pressure in the intake chamber being greater than the pressure in the recovery chamber; and recovering the purified steam from the recovery chamber of the vessel.

### FIELD OF THE INVENTION

This invention relates to membranes and a process of making the membrane for the separation, purification and recovery of steam. The invention also relates to a membrane process for the separation, purification and recovery of industrial steam.

### BACKGROUND OF THE INVENTION

Steam is the most universal energy carrier. Its application is wide spread and can be found in all aspects of industrial processes. The biggest steam user is thermal power stations where steam is used to generate electricity. The steam consumption in a typical thermal power station of a 1,000 MW capacity is about 2,800 t/h which translates to about 800 kg condensate per second.

Industry converts more than 70% of the fuel it purchases for energy into steam. For example, the US pulp and paper industry used approximately 2,197 trillion Btu/year of energy to generate steam, accounting for about 83 percent of the total energy used by this industry. The chemicals industry used approximately 1,855 trillion Btu of energy to generate steam, which represents about 57 percent of the total energy used in this industry. The petroleum refining industry used about 1,373 trillion Btus of energy to generate steam, which accounts for about 42 percent of this industry's total energy usage.

Fuel cost is the main component in the cost of steam production. Other costs include the water cost, pre-treatment, etc. Other factors such as the water inlet temperature and the pressure/temperature of the product steam also affect the cost of steam generation. In general, the steam cost is estimated to be US $20/ton.

Steam is almost exclusively produced in boilers, the efficiency of which is about 70-80% %. Steam is also generated as a by product of processes such as evaporator, or when water is used as the cooling medium. After transferring its energy, the pressure and temperature of the steam drop significantly. During the process, it is contaminated with volatile chemicals and gases such as air and carbon dioxide. A common practice to deal with spent steam is to use a condenser to collect the water or to discharge the steam to atmosphere. Discharging the spent steam to atmosphere is not only an energy loss but at the same time an environmental issue.

Spent steam can be found almost in every plant/factory where steam is used. From big industrial establishments such as refineries, power plants, chemical factories, steel makers, ore mining, to medium and small plants such as sugar mills, food processing, even to end users such as car washes. Waste steam is also a by product of processes such as evaporation, drying, cleaning, etc.

With a higher energy cost and a growing concern regarding environmental effect, it's highly desirable to recover the energy loss by recycling the spent steam. The first step in this process would be to remove/separate steam from other gaseous/volatile impurities.

Industrial interest has stimulated numerous investigations into methods of separating and recovering spent steam for both economical and environmental benefits. Although there are number of commercially important membrane separation process (such as reverse osmosis, nanofiltration and ultrafiltration) available for the purification of waste water streams at ambient temperatures. There is a different need to economically purify high temperature steam (e.g. at temperatures from about 100 to about 160° C.) while retaining the thermal energy of the steam. Commercial membranes presently available are not able to survive the conditions required to provide an economically viable separation process. For example, there is a vast amount of literature available on PVA membranes used in the purification of waste water. It is known that high cross-linking ratios in PVA give membranes relatively stable at higher temperatures, but that this stability comes at the expense of useful flux ratios.

Accordingly, it's an objective of the present invention to overcome, or at least alleviate, the difficulties presented by prior art steam purification as conducted by membrane separation processes.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

This invention relates to a method of making composite membranes and a membrane process for steam separation and recovery. It provides applications for any industrial spent steam containing air or different gases, volatile chemicals, oil traces etc.

The technique relies on the separation capability of the designed membrane that allows steam to pass selectively through while preventing air and other volatile material including dissolved matter to pass. The resulting steam separation takes place at the temperature of the waste steam, and the product is highly pure saturated steam at a relatively reduced temperature and pressure.

In one aspect, the invention provides a separation membrane comprising
at least one porous support having a membrane material applied thereto, the membrane material comprising:
about 45 wt % to about 95 wt % hydrophilic polymer and;
greater than about 1 wt % to about 50 wt % inorganic particulate material or a precursor to an inorganic particulate material.

In a preferred form of the invention the membrane material may further comprise up to about 20 wt % of a cross-linking agent. While other materials which do not affect or detract from the properties of the membrane in the context of the invention may be present, preferably the hydrophilic polymer, inorganic particulate or precursor and optional cross-linking agent total 100% of the membrane.

The separation membrane, including the porous support, membrane material and cross-linking agent, can withstand steam at high temperatures for prolonged times (i.e. is physically and chemically stable over the duration). For instance, the separation membrane, and the porous support, the membrane material and cross-linking agent, is stable at temperatures of about 100 to about 160° C. for a duration of application.

The porous support, which may alternatively be referred to as a porous substrate (i.e. where the function of supporting is not essential) may be selected from any suitable supports such as PTFE, nylon, poly sulfone, cellulosic paper ceramics and porous metals, or a combination of these. A second porous support is preferably placed on top to form a sandwich-like separation membrane (i.e. first porous support, membrane material, and then second porous support). The separation membrane may be further supported on a physically strong porous support to withstand higher pressures as commonly used in standard membrane technology.

By ‘applied thereto’ it is meant that the membrane material may be, for instance, placed on, adhered to, bonded to, embedded into or onto, or otherwise attached to the porous support. The membrane material is preferably embedded onto at least one porous support. In a preferred form of the invention, the membrane material is sandwiched between more than one porous support.

In order to prepare the membrane, the membrane material may be applied to the porous support by any suitable known techniques such as casting, or spin coating. For instance, a layer of the membrane material may be coated on the support by spin coating or draw coating if a thinner active layer is needed. In these embodiments, the casting solvent may be water or a strongly polar solvent such as dimethyl sulfoxide (DMSO). As discussed herein, the membrane material itself may also be considered a composite (i.e. with the inorganic particulate material).

Accordingly, in another aspect of the invention there is provided a separation membrane comprising
at least one porous support; and
a cross-linked hydrophilic polymer membrane material comprising an inorganic particulate material or a precursor to an inorganic particulate material, the polymer membrane being applied to the porous support,
wherein the porous support and the membrane material form a separation material.

Preferably, two porous supports are provided with the membrane material therebetween. The membrane material is preferably sandwiched between two porous supports.

According to the invention, highly hydrophilic polymers such as polyvinyl alcohol (PVA) are the preferred material for the membrane material, although other hydrophilic polymers, for instance those selected from the group of modified polyimides, or cellulose acetate can be used

The polymer also has to have the ability to sufficiently interact with the inorganic phase (the inorganic particulate material included in the membrane material). As those skilled in the preparation of organic polymer/inorganic particulate composites would understand, the degree of interaction achievable and required varies among components and applications. In the present invention, the interaction is preferably sufficient to result in a dispersion or distribution of the inorganic particulate material throughout the membrane material. The interaction may be physical and/or chemical. Preferably, the interaction is sufficiently strong so as to be referred to as an attachment.

The cross-linking agent for the polymer may, for instance, be selected from the group of aldehydes such as glutaraldehyde, or carboxylic acids such as maleic acid and citric acid. An important feature of the invention is that the polymer and the cross-linking agent are sufficiently chemically stable at the elevated temperatures of use. The cross-linking for the polymer inorganic composite may be provided simply by the addition of heat.

Without wishing to be bound by theory, the inventors believe that an important feature of the invention is the effect the inorganic particulate component has on the properties of the polymer matrix.

In the membrane material of the invention, that is as it would be when in use, the inorganic particulate material is preferably dispersed throughout the polymer as discrete units of dimension ranging from about 5 to about 500 nm.

Preferably, a precursor to the inorganic particulate material is added. In these embodiments, the membrane material will include an inorganic particulate material that has formed in situ during the use or further processing of the membrane material. For instance, organometallic compounds or commercially available nanoparticles in emulsion may be used as precursors for silica or other nano-inorganics. The skilled person would be able to source such precursors and/or inorganic particulate materials.

In a particularly preferred embodiment, the hydrophilic polymer is PVA, the precursor to the inorganic particulate precursor is tetraethylorthosilicate (TEOS) (resulting in a silica inorganic particulate material) and the cross-linking agent is maleic acid. A small amount of catalyst may be used to assist the cross-linking reaction.

The membrane material may also contain one or more additional components such as, for instance, (i) hydrophilic ionic liquids which may further alter chemical physical properties of the membrane and may enhance its water transport properties or (ii) surface binding agents such as alpha-glycidoxypropyltrimethoxysilane.

In a further aspect, the present invention provides a process for preparing a separation membrane, the process including the step of applying a membrane material to a porous support, the membrane comprising
about 45 wt % to about 95 wt % hydrophilic polymer;
greater than about 1 wt % to about 50 wt % inorganic particulate material or a precursor to an inorganic particulate material; and
greater than zero and up to about 20 wt % of a cross-linking agent.

While other materials which do not affect or detract from the properties of the membrane in the context of the invention may be present, preferably the hydrophilic polymer, inorganic particulate or precursor and optional cross-linking agent total 100% of the membrane.

The process of the above aspect further includes the step of heating the membrane material. This further step may be conducted prior to a first use of the separation membrane (e.g. as a conditioning step conducted by the manufacturer) or as part of the use of the separation membrane. The exact conditions required depend on the composition of the membrane material. The temperature of heating may be from about 100° C. to about 160° C. A period of time greater than about 2 hours is preferable for this step.

The invention further provides a process of steam separation comprising the steps of:
providing a separation membrane in a separation vessel, the separation membrane separating the vessel into an intake chamber and a recovery chamber, the separation membrane comprising:
   at least one porous support; and
   a cross-linked hydrophilic polymer membrane material comprising an inorganic particulate material or a precursor to an inorganic particulate material, the membrane material being applied to the porous support;
supplying steam to be purified to the intake chamber of the vessel, the pressure in the intake chamber being greater than the pressure in the recovery chamber; and
recovering the purified steam from the recovery chamber of the vessel.

While other materials which do not affect or detract from the properties of the membrane in the context of the invention may be present, preferably the hydrophilic polymer, inorganic particulate or precursor and optional cross-linking agent total 100% of the membrane. In a further aspect of the invention there is provided an apparatus for purifying and recovering steam comprising a vessel, a separation membrane dividing the interior of the vessel into an intake chamber and a recovery chamber, the pressure in the intake chamber being capable of being greater than the pressure in the recovery chamber during use.

The vessel may be a stand alone pressure vessel or it may be a steam conduit connected to the steam source.

It will also be understood that the term “comprises” (or its grammatical variants) as used in this specification is equivalent to the term “includes” and should not be taken as excluding the presence of other elements or features.

Further features objects and advantages will become more apparent from the following description of the preferred embodiment and accompanying drawings.

### BRIEF DESCRIPTION OF THE DRAWINGS

FIG. 1 is a schematic view of a sandwich like separation membrane in accordance with the invention; and

FIG. 2 is a flow diagram of the steam separation and recovery process in accordance with another embodiment of the invention.

### DETAILED DESCRIPTION OF THE EMBODIMENTS

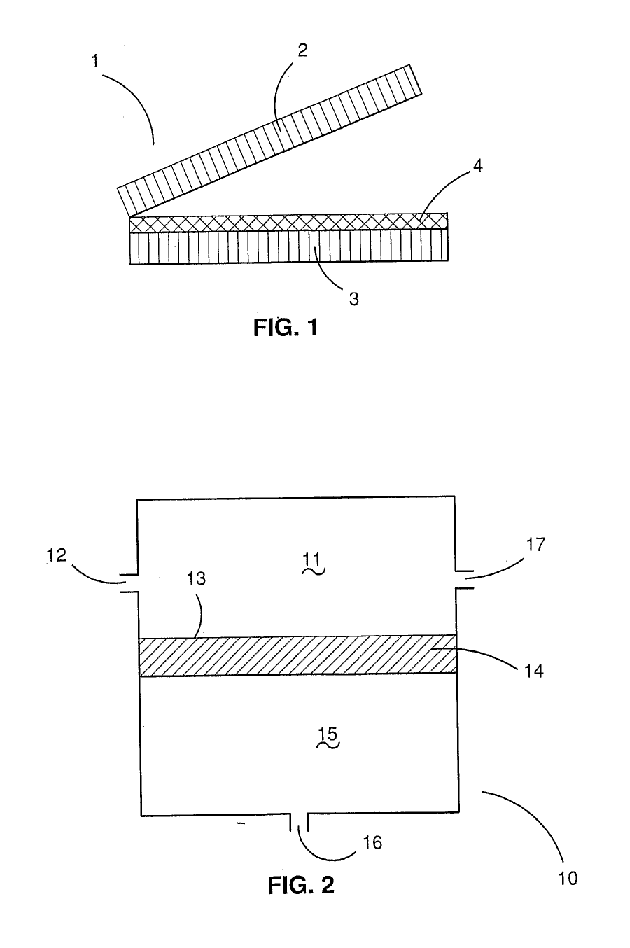

Referring to FIG. 1, the separation membrane 1 in accordance with the invention is shown comprising two porous supports 2, 3 and a membrane material 4 (labelled ‘polymer thin film’) applied to the porous support 2, 3.

The porous support 2, 3 has a pore size in the range from submicron to a few micrometer (with the preferred range being less than 2 micrometer), and a thickness in the range of 1 to 100 micrometer. Suitable materials for the porous support include PTFE, polysulfone, nylon, cellulosic paper, ceramics and porous metals, or a combination of these. It is a requirement of the porous support that it be (i) porous, (ii) have sufficient physical and chemical properties (e.g. rigidity, mechanical strength, and inertness) and (iii) be stable at temperatures up to about 200° C. and under an applied pressure differential of up to about 10 bars across, the separation membrane.

In those embodiments having 2 porous supports sandwiching the membrane material, the material of the porous support for each sides of the membrane can be different. For example, a high mechanical strength material can be used as lower porous support 2 while hydrophilic PTFE may be used as upper porous support 3 to improve water transport.

Depending on the method of preparation, the membrane thickness may vary from 1 micrometer to 100 micrometers. The membrane material can be a stand alone film (i.e. prior to application to the porous support) or a thin film cast directly onto the porous support. The membrane material comprises a hydrophilic polymer matrix with an inorganic particulate material or a precursor to an inorganic material dispersed throughout or mixed in the polymer matrix. The particulate material is dispersed in an amount of about 1 wt % to about 50 wt %, but possibly in a preferred range of 1 wt % to 25 wt %.

Suitable hydrophilic polymers including PVA or hydrophilic PI (polyimide) with functional groups capable of bonding, or at least interacting, with the inorganic particulate material are used. The membrane material contains an inorganic particulate material, or a precursor to an inorganic particulate material which later converts into inorganic particles under known conditions. Suitable inorganic particulate materials including silica, alumina, and their organometallic precursors such as tetraethylorthosilicate (TEOS). The particulate material eventually formed or originally present in the membrane material has a particle size between 5 and 500 nm.

In addition to combining the hydrophilic polymer with the inorganic component, a cross-linking agent may be added to the polymer. The cross-linking of the polymer may be used to modify the water absorption characteristics of the polymer materials with the aim of balancing the selectivity (e.g. of water/steam over the impurities) and stability. For example, suitable cross-linking agents for PVA may be selected from the group of aldehydes such as glutaraldehyde, or carboxylic acids such as maleic acid and citric acid.

Referring to FIG. 2, a flow diagram for steam recovery is shown. The steam to be purified enters the intake chamber 11 of a vessel 10 through intake 12 and contacts the upper side 13 of the composite membrane 14. The waste steam containing gaseous impurities is at a pressure from 1 bar to 6 bar and at a temperature ranging from 110° C. to 145° C. Steam/water is transported selectively through the membrane 14 and is collected in the recovery chamber 15 in the form of high purity steam at a reduced pressure and temperature through recovery outlet 16. The gas/volatile impurities are discharged from the intake chamber through discharge 17. The pressure difference between the two chambers may be a small as 1 bar for the apparatus to work. For practical reasons, the membranes are produced to withstand a pressure differential of up to 10 bars. The temperature of the clean steam can be increased by heat exchanging from the feed stream, thus super heated steam is attainable.

To further illustrate the process of this invention, the following examples are provided. It should be understood that the details thereof are not to be regarded as limitations and various modifications may be made without departing from the spirit of the invention.

### EXAMPLES

### Example 1

Solution A: Up to 7.5 wt % PVA in water (e.g. 7.5 g PVA per 100 g water)) was prepared by dissolving PVA in water under boiling with reflux for two hours. The solution was then cooled to room temperature before being acidified with HCl. Solution B was prepared by mixing tetraethylorthosilicate (TEOS) in ethanol (EtOH). The concentration of TEOS in Solution B was about 1.5 wt %. Solution B was then added to solution A under stirring. The amount of solution B added determines the silica content in the final composite. The mixture was kept under stirring for another 30 minutes after the completion of the addition. The mixture was then poured into a mould. The mould was then covered and the mixture left to dry in air or a vacuum oven at room temperature over several days. An inorganic-organic composite was formed in the shape of a thin film. It was then removed from the mould and subjected to a cross-linking step where heat is used to induce the cross-linking between the membrane components. The resulting membrane was clear and transparent. SEM analysis showed silica particles dispersed in the PVA membrane material. The dimension of the silica particles were up to 500 nm. The silica content of the material can be as high as 50 wt %. This result was confirmed by weight loss upon ignition analysis.

### Example 2

As for example 1 except that H₂SO₄ was used instead of HCl. The analysis of the material showed it to be similar.

### Example 3

A Solution C was prepared according to solution A in example 1 except that a small amount (up to 10 wt %) of a cross-linking agent (maleic acid or glutaraldehyde) was added. Solution C was then acidified and mixed with solution B as in Example 1. The cross-linking agents provided extra bonding to prevent the swelling of PVA in the presence of water, especially at elevated temperatures.

### Example 4

Solution D containing silica particles was prepared by means of a sol gel reaction using TEOS in water at low temperature or by incorporating silica nanoparticles from a silica particle emulsion. The particle size was in the nano to sub micrometer range preferably between 5 to 500 nm. Solution D was added to the final solutions in examples 1 and 2 and a membrane was produced from the resulting solution. Example 5: Solution F was prepared by stirring 5% w/v PVA in DMSO at 90-100° C. for 2 hours. The PVA solution was cooled to room temperature before adding maleic anhydride as the cross-linking agent (up to 20% w/w) then followed by paratoluene sulfonic acid (1-2% w/w) as catalyst. The mixture was stirred at 120° C. for 2 hours then allowed to cool to room temperature. Solution D was then added to solution F under stirring. The amount of solution D added determines the silica content in the final composite. The mixture was stirring for another 30 minutes after the addition.

### Example 6

The heat treated PVA film prepared according to examples 1-5 was cut and placed between two porous supports having pores in sub-micro sizes, such as PTFE to form a separation membrane. The thickness of the polymer film and porous support may vary from 1 to 100 micrometers.

### Example 7

The PVA solution prepared in examples 1-5 was coated on the porous support by means of tape casting to form a separation membrane. The separation membrane was then subjected to a heat treatment from 100-160° C. Depending on the coating method and the porous support used, the thickness of the polymer layer may vary from 1 to 10 micrometers.

### Example 8

The PVA film was put between 2 pieces of porous support before the heat treatment to form a sandwich like PVA separation membrane.

### Example 9

Polyimide (PI) with designed functional groups was dissolved in suitable solvents such as NMP or THF. Silica organic compounds such as TEOS, 3-amino-propyl triethoxy silane (APTEOS), or alpha-glycidoxypropyltrimethyoxysilane (GPTMOS) as a source of the inorganic particles was then added. The bonds between organic and inorganic phases were formed via the reaction between the amine groups of the APTEOS or the epoxy groups of the GPTMOS and the imide molecular structure. PI composite membrane was then prepared by casting or spin coating the resulting solution. The film was then subjected to a heat treatment.

### Example 10

Membranes of examples 6-9 were trialled in a stream separation apparatus of the invention shown in FIG. 2. The steam separation and purification was conducted in a simple reactor consisting of an intake chamber (chamber A) for spent steam and a recovery chamber (chamber B) where pure team was collected. A mixture of steam and air was injected into chamber A at 145° C. and at a pressure of 6 bars. Steam from chamber A passed through the membrane to chamber B. The pressure in chamber B was maintained constant at 2 bars where high purity steam was collected. The steam recovery was measured, as the rate of steam condensed from chamber B.

In these experiments, when the pressure difference between the chambers was 6 bars, the rate of steam passing through the membrane was 150 kg/m²/h for membranes from example 6 and 70 kg/m²/h for membrane from example 7.

It will be understood that the invention disclosed and defined in this specification extends to all alternative combinations of two or more of the individual features mentioned or evident from the text or drawings. All of these different combinations constitute various alternative aspects of the invention.

1. A process of steam separation comprising the steps of:
providing a separation membrane in a separation vessel, the separation membrane separating the vessel into an intake chamber and a recovery chamber, the separation membrane comprising:
at least one porous support; and
a cross-linked hydrophilic polymer membrane material comprising an inorganic particulate material or a precursor to an inorganic particulate material, the membrane material being applied to the porous support; and
supplying steam to be purified to the intake chamber of the vessel, the pressure in the intake chamber being greater than the pressure in the recovery chamber; and
recovering the purified steam from the recovery chamber of the vessel.

2. A process of steam separation comprising the steps of
providing a separation membrane in a separation vessel, the separation membrane separating the vessel into an intake chamber and a recovery chamber, the membrane comprising
at least one porous support,
about 45 wt % to about 95 wt % hydrophilic polymer; and
greater than about 1 wt % to about 50 wt % inorganic particulate material or a precursor to an inorganic particulate material;
supplying steam to be purified to the intake chamber of the vessel, the pressure in the intake chamber being greater than the pressure in the recovery chamber; and
recovering the purified steam from the recovery chamber of the vessel.

3. The process of claim 2 wherein the pressure differential between the intake chamber and the recovery chamber is between 1 and 6 bar.

4. A separation membrane comprising at least one porous support having a membrane material applied thereto, the membrane material comprising:
about 45 wt % to about 95 wt % hydrophilic polymer;
greater than about 1 wt % to about 50 wt % inorganic particulate material or a precursor to an inorganic particulate material; and
optionally up to about 20 wt % of a cross-linking agent.

5. A separation membrane comprising:
at least one porous support; and
a hydrophilic polymer membrane material cross-linked by a cross-linking agent and comprising an inorganic particulate material or a precursor to an inorganic particulate material, the polymer membrane being applied to the porous support,
wherein the porous support and the membrane material form a composite separation material.

6. The separation membrane according to claim 5, wherein the membrane material on the porous support or embedded into the pores of the porous support.

7. The separation membrane according to claim, 5 wherein the inorganic particulate material is dispersed substantially evenly throughout the membrane material.

8. The separation membrane according to claim 7 wherein the inorganic particulate material is dispersed throughout the polymer discretely where the average particle size dimension is 5 to 500 nm.

9. The separation membrane of claim 4 wherein the membrane thickness is between 1 and 100 microns.

10. The separation membrane of claim 5 further comprising a second porous support, the membrane material being between the two porous supports.

11. A process for preparing a separation membrane, the process including the step of
applying a membrane material to a porous support, the membrane comprising
about 45 wt % to about 95 wt % hydrophilic polymer;
greater than about 1 wt % to about 50 wt % inorganic particulate material or a precursor to an inorganic particulate material; and
optionally, greater than zero and up to about 20 wt % of a cross-linking agent.

12. The process for preparing a separation membrane according to claim 11 further including the step of heating the separation membrane.

13. The process for preparing a separation membrane according to claim 12, wherein the temperature of heating is from about 100° C. to about 160° C.

14. An apparatus for purifying and recovering steam comprising a vessel, the composite separation membrane of claim 5 dividing the interior of the vessel into an intake chamber for the addition of steam to be purified and a recovery chamber for recovering purified steam.
